(19) United States
(12) Patent Application Publication
(10) Pub. No.: US 2002/0135635 A1
(43) Pub. Date: Sep. 26, 2002

(54) Method and apparatus for generating a print image in a number of steps

(75) Inventor: Mathias Karlhuber, Berlin (DE)

Correspondence Address: SCHIFF HARDIN & WAITE, Patent Department, 6600 Sears Tower, 233 South Wacker Drive, Chicago, IL, 60606, US

(73) Assignee: Francotyp-Postalia AG & Co. KG

(21) Appl. No.: 10/102,135

(22) Filed: Mar. 20, 2002

(30) Foreign Application Priority Data
Mar. 21, 2001 (DE) 101 14 527.6

(51) Int. Cl. B41J 2/145

(52) U.S. Cl. 347/43; 347/41

(57) ABSTRACT

In a method and apparatus for generating a print image, particularly a franking imprint, on an image carrier composed of at least one first partial image and a second partial image that are transversely offset relative to a first direction, a relative motion between a drop-ejecting print head and the image carrier is generated along the first direction in a first step for generating the first partial image, a transverse offset between the print head and the image carrier is generated in a second direction proceeding transversely to the first direction in a second step, and a relative motion between the print head and the image carrier is generated along the first direction in a third step for generating the second partial image. The transverse offset in the second step is selected such that an overlap region between the first and second partial images exists, and first ink drops are ejected in the overlap region in the first and third steps with the drop mass of the first ink drops being controlled such that an essentially smooth transition occurs between the first and second partial images.

### BACKGROUND OF THE INVENTION

1. Field of the Invention

The present invention is directed to a method and apparatus for generating a print image, particularly a franking imprint, on an image carrier of the type wherein the print image is composed of at least one first partial image and a second partial image that are transversely offset relative to a first direction, wherein a relative motion between a drop-ejecting print head and the image carrier is generated along the first direction in a first step for generating the first partial image, a transverse offset between the print head and the image carrier is generated in a second direction proceeding transversely to the first direction in a second step, and a relative motion between the print head and the image carrier is generated along the first direction in a third step for generating the second partial image.

2. Description of the Prior Art

When generating franking imprints as well as when generating other types of print images, it is usually necessary to achieve a clean, transition-free and continuous print image since this will usually be subsequently subjected to a check using an image recognition method, and the recognition rate higher the cleaner the print image is. P articularly in the case of franking imprints that include a two-dimensional bar code with critical informational content, it is of importance to obtain a smooth, gap-free transition between the two partial images in order not to falsify the recognition result.

European Application 0 933 210 discloses a method of the type described above, as well as a corresponding apparatus wherein individual nozzles of the print head are activated or deactivated in order to achieve an exact alignment of the two partial images relative to one another in the second direction. The two regions printable with the print head thereby overlap, and individual nozzles at the edge are not used for printing in order to prevent both an overlap of the two printed partial images as well as to prevent the creation of a gap. Not only a gap but also an overlap of the two partial images must be avoided insofar as possible because if the two partial images were to overlap, too much ink would be applied onto the image carrier—usually a letter—in the overlapping regions, with the consequence that the contours of the print image become blurred. Particularly in the case of two-dimensional bar codes, this in turn leads to a significant reduction in the recognition performance.

This known apparatus allows alignment only with electronic means rather than with a far more complicated mechanical adjustment of the transverse offset mechanism for the print head. It has the disadvantage, however, that a rather complicated determination must be made for each apparatus as to how many nozzles of the print head must be deactivated in the edge region. Due to an imprecise matching or as a result of wear over time of the components holding the print head in its two transverse positions, a gap nonetheless can arise between the two partial images.

### SUMMARY OF THE INVENTION

An object of the present invention is to provide a method and an apparatus of the type initially described wherein the aforementioned disadvantages do not occur or at least occur to a lesser extent, and in particular, which produces a print image with a high recognition rate for machine-based image recognition due to good alignment of the partial images, and wherein such alignment is achieved in a simple manner.

The above object is achieved in accordance with the principles of the present invention in a method and an apparatus for generating a print image, particularly a franking imprint, on an image carrier composed of at least one first partial image and a second partial image disposed transversely offset relative to a first direction, wherein a relative motion between an ink droplet-ejecting printhead and an image carrier is generated along the first direction in a first step for generating the partial image, a transverse offset between the printhead and the image carrier is generated in a second direction, transverse to the first direction, in a second step, and a relative motion between the printhead and the image carrier is generated along the first direction in a third step for generating the second partial image, and wherein the transverse offset in the second step is selected so that an overlap region between the first and second partial images exists, with first ink drops that are ejected in this overlap region in the first and third steps having a drop mass that is controlled so that a substantially smooth transition occurs between the first and second partial images.

The present invention is based on the recognition that good alignment of the two partial print images relative to one another is simply achieved by selecting the transverse offset in the second step such that an overlap region between the first and second partial images exists, and by ejecting first ink drops in the overlap region in the first and third steps with the drop mass of the first ink drops being controlled such that an essentially smooth transition derives between the first and second partial images.

By providing the overlap region between the two partial images, it is assured that no undesired gaps arise between the two partial print images even given wear or an imprecise matching between the print images. By controlling the drop mass, it is in turn assured that too much ink compared to the remaining image areas will not be applied onto the image carrier in the overlap region. Accordingly, a blurring of the edge contours of the print image that degrades the recognition rate does not occur with the invention, or at least such blurring, if it exists, is significantly reduced.

A determination must be made in the context of the invention of the extent to which the two partial images overlap, given the mechanical tolerances of the transverse offset mechanism of the print head, and of the number of nozzles in the edge region for which control of the drop mass, i.e. reduction of the drop mass, must occur. Nevertheless, the outlay for these determinations can be kept low since imprecisions are of far less significance given a suitably selected drop mass. Regions of the partial images that lie outside the overlap region but which are nonetheless printed with drops having a reduced drop mass due to imprecisions are of practically no significance in the image recognition, since a closed print image is generated and this merely offers somewhat less contrast due to the lower drop mass.

The drop mass can be controlled in any suitable way. The type of control is dependent on the printing principle employed. In the case of piezo ink jet print heads, the drop mass can be set in a known way via the pulse amplitude and frequency or the timing of the control pulses at the appertaining piezo element. In bubble jet ink jet print heads, the control can likewise be undertaken in a known way, for example via the drive voltage and the timing of the drive.

It is also possible to reduce the resolution of the print head in the overlap region by driving, for example, only every other print element, i.e. the print mass of the intervening print elements is thus set to zero. The first drops ejected in the overlap region in the first and third step then augment one another to form a complete print image. The first drops of the remaining nozzles can have the same drop mass as the second drops ejected outside the overlap region. Alternatively, they can have a lower drop mass than the second drops in order to assure that the above-described blurring of the edge contours does not occur given an imprecise alignment of the nozzles in the first and third steps, by avoiding too great a coverage of the first drops from the first and third steps in the overlap region.

The first drops ejected in the third step preferably overlap the first drops ejected in the first step. The term “overlap” is used herein in the sense of an overlap of the image appearance arising on the image carrier. This is intended to include not only first drops lying on top of one another with dot precision, but also includes the situation of first drops only partly covering one another as well as first drops that occupy an interconnected area on the image carrier only in terms of their image appearance.

In a preferred embodiment of the inventive method, the drop mass of the first ink drops in the first and third steps is selected such that the size of the dot on the image carrier generated with the superimposed first ink drops in the overlap region essentially corresponds to the size of a dot on the image carrier generated with a second ink drop ejected onto the image carrier outside the overlap region. An especially smooth, transition-free alignment between the two partial images is achieved as a result.

In order to dependably achieve this, the total mass of the first drops that are superimposed on one another is preferably greater than the drop mass of the aforementioned second ink drop.

In a further embodiment of the inventive method the drop mass of the first drops decreases toward the edge of each partial image. Due to larger drops being ejected at the edges of the overlap region, any shift between the two partial images is of little significance or is of no significance, in terms of the image appearance given an imprecise alignment between the two partial images due to imprecise alignment control or due to wear.

As mentioned above, the first drops ejected in the first and third steps may only partially overlap one another, at least in terms of the image appearance that arises. In preferred versions of the invention, the ejection time of the first ink drops in the first and third steps is selected such that the size of the dot on the image carrier generated with the superimposed first ink drops in the overlap region essentially corresponds to the size of a dot on the image carrier generated with a second ink drop ejected onto the image carrier outside the overlap region.

If, given a dot-precise overlap of two first drops, a higher overall mass of the two drops must be selected compared to a drop outside the overlap region, an overall mass that is lower compared to the dot-precise overlap can be advantageously employed due to the offset incidence of the drops onto the image carrier.

The present invention is also directed to a corresponding apparatus for generating a print image, particularly a franking imprint, on an image carrier composed of at least one first partial image and a second partial image that are transversely offset relative to a first direction. This apparatus has a drop-ejecting print head, a drive unit for generating relative motions between the print head and the image carrier, as well as a control device connected to the drive unit and to the print head. The drive unit and the control device are fashioned for generating the first partial image in a first step with a relative motion between the print head and the image carrier along a first direction, for generating a transverse offset between print head and image carrier along a second direction proceeding transversely relative to the first direction in a second step, and for generating the second partial image in a third step given a relative motion between print head and image carrier along the first direction.

Inventively, the transverse offset in the second step is selected such that an overlap region exists between the first and second partial images, and the control device includes a drop mass control unit that controls the drop mass of first ink drops ejected in the overlap region in the first and third steps so that an essentially smooth transition between the first and second partial images occurs. The advantages that have already described in detail above are achieved in the same way with such an apparatus as with the inventive method.

Preferably, the drop mass control unit for controlling the drop mass of the ink drops in the first and third steps controls the size of the dot on the image carrier generated with the superimposed first ink drops in the overlap region so that this size essentially corresponds to the size of a dot on the image carrier generated with a second ink drop ejected onto the image carrier outside the overlap region. As mentioned above, an especially smooth, transition-free alignment between the two partial images is achieved as a result.

In other preferred versions of the inventive apparatus, the control device includes a time control unit that is fashioned such for the control of the ejection time of the first ink drops in the first and third steps so that the size of the dot on the image carrier generated with the superimposed first ink drops in the overlap region essentially corresponds to the size of a dot on the image carrier generated with a second ink drop ejected onto the image carrier outside the overlap region.

### DESCRIPTION OF THE DRAWINGS

FIG. 1 is a schematic illustration of a portion partial view of an inventive apparatus.

FIG. 2 is an enlarged schematic illustration of a franking imprint produced with the apparatus of FIG. 1.

FIG. 3 is a schematic illustration of a portion of picture elements generated on the image carrier with the apparatus of FIG. 1.

FIG. 4 is a schematic illustration of a portion of the picture elements generated on an image carrier with another preferred embodiment of the invention.

### DESCRIPTION OF THE PREFERRED EMBODIMENTS

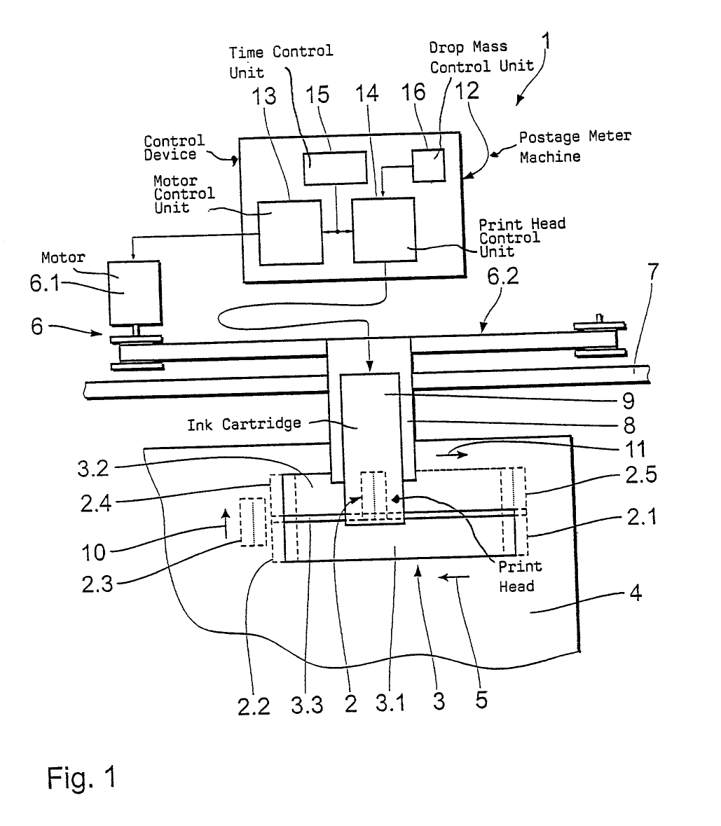

FIG. 1 shows a portion of an inventive apparatus in the form of a postage meter machine 1 having a print head 2 for generating a print image in the form of a franking imprint 3 on a letter 4 representing the image carrier. The franking imprint 3 is composed of two partial images 3.1 and 3.2 offset transversely relative to a first direction 5 that overlap one another in an overlap region 3.3 and supplement one another to form the franking imprint 3.

For generating the two partial images 3.1 and 3.2, a first drive unit 6 having a motor 6.1 and a belt 6.2 driven by the motor 6.1 are provided, the belt 6.2 being connected to a mount 8 conducted through a longitudinal guide 7 along the first direction 5. A cartridge 9 with the print head 2 is seated in the mount 8 so as to be displaceable transversely to the first direction 5. The cartridge 9 and thus the print head 2 can be offset transversely to the first direction 5 with a second drive unit (not shown).

The cartridge 9 in the illustrated example is an ink cartridge integrated with the ink jet print head 2, however, the invention can be employed in conjunction with drop-ejecting print heads that operate based on other printing principles.

For generating the first partial image 3.1, the print head 2, proceeding from a first position indicated by the outline 2.1 wherein the printing event begins, is moved in the first direction 5 with respect to the stationary letter 4 into a second position indicated by the outline 2.2 in a first step, the initial printing event ending at that position. Subsequently, the print head 2 is displaced transversely relative to the first direction 5 in a second direction 10 on a route via a third position indicated by the outline 2.3 in a second step. Subsequently, the print head 2, proceeding from a fourth position indicated by the outline 2.4 wherein printing event begins again, is moved along the first direction 5 in the direction of the arrow 11 into a fifth position indicated by the outline 2.5 in a third step for generating the second partial image 3.2, the printing event ending at this fifth position.

It is clear that only the relative motion between the print head 2 and image carrier 4 is of concern in the invention. Accordingly, the image carrier 4 or print head 2 and image carrier 4 can be correspondingly moved in a known way in other versions of the invention.

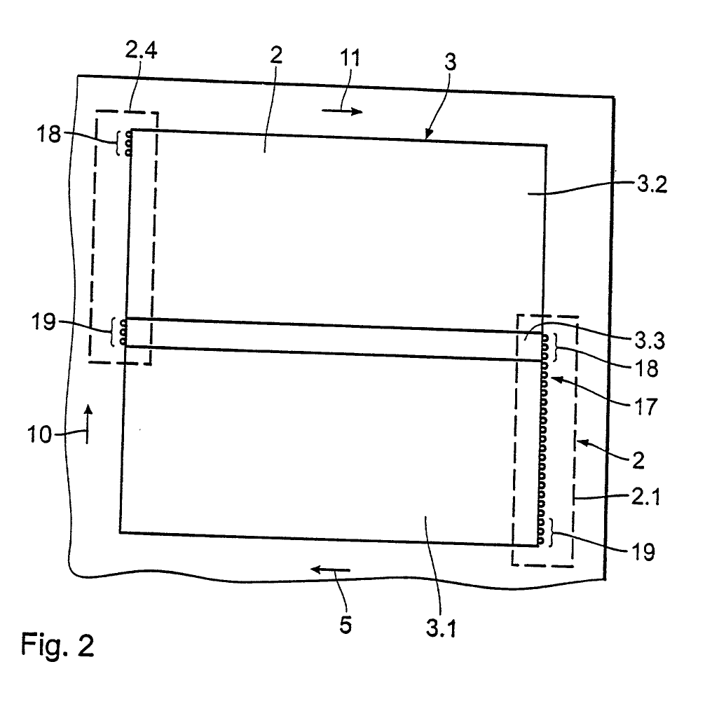

In order to obtain two partial images 3.1 and 3.2 that supplement one another to form the franking imprint 3, as can be seen in the example of FIG. 2, a control device 12 connected to the print head 2 and the motor 6.1 in a conventional way is provided, which synchronizes the drive of print head 2 and the motor 6.1. Due to this synchronization, no longitudinal offset along the first direction 5 arises between the two partial images 3.1 and 3.2, so that a transition-free franking imprint 3 is produced.

The control device 12 has a motor control unit 13 and a print head control unit 14 as well as a time control unit 15 connected to the motor control unit 13 and the print head control unit 14. This time control unit 15 synchronizes the drive of motor 6.1 and the print head 2 with the motor control unit 13 and the print head control unit 14.

The control unit 12 also has a drop mass control unit 16 connected to the print head control unit 14 controls the drop mass of the first ink drops ejected into the overlap region 3.3 during the first and third steps.

The drop mass control shall now be presented with reference to FIG. 2, which shows the enlarged, schematic franking imprint 3 from FIG. 1.

In the first step, the drop mass control unit 16 controls the nozzles 17 of the print head 2, which is shown by the outline 2.1 in its first position, so that the nozzle group 18, sweeping across the overlap region 3.3 when the print head 2 is moved in the first direction, ejects first ink drops. These first ink drops have a reduced drop mass compared to second ink drops ejected with the remaining nozzles, all of these having the same drop mass.

After the print head 2 is displaced in the direction of the arrow 10 in the second step and, in the third step, has reached its fourth position—indicated in FIG. 2 by the outline 2.4—in which the printing event is resumed, it is moved in the direction of the arrow 11 for generating the second partial image 3.2. The drop mass control unit 16 thereby controls the nozzles 17 of the print head 2 so that the nozzle group 18, now sweeping across the overlap region 3.3 when the print head 2 is moved in the direction of the arrow 11, ejects first ink drops. These first ink drops again have a reduced drop mass compared to the second ink drops ejected with the remaining nozzles, all of these having the same drop mass.

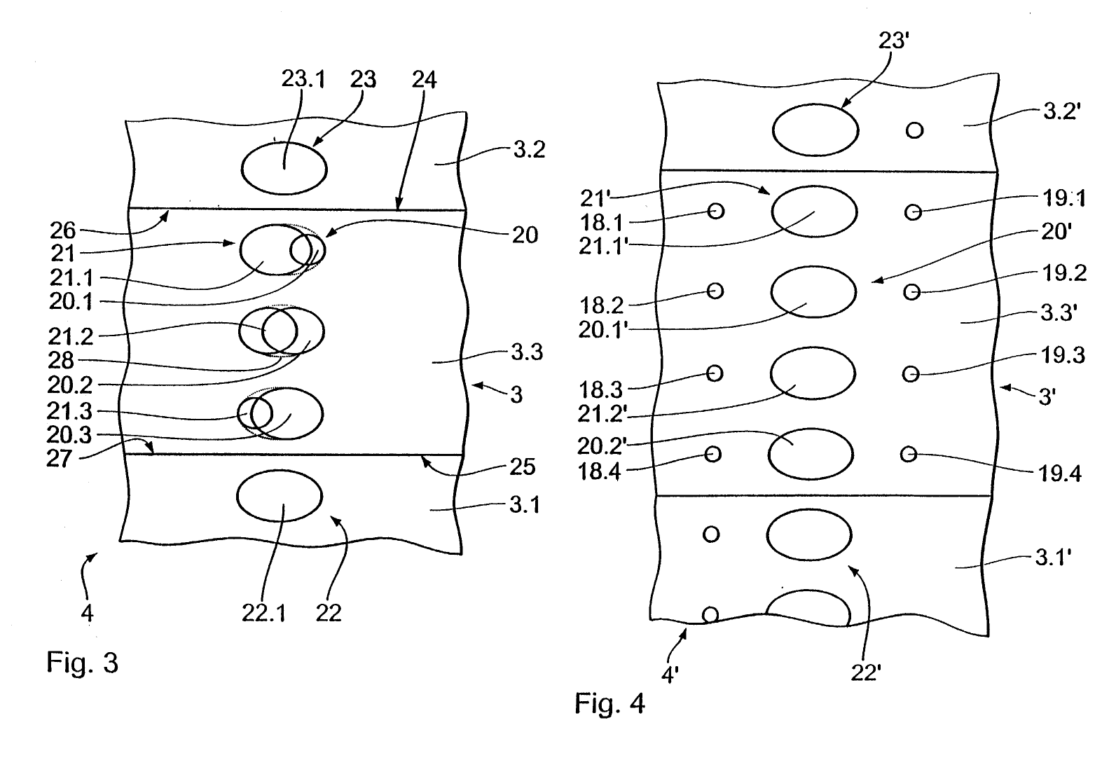

FIG. 3 shows a schematic partial view of picture element groups 20, 21, 22 and 23 generated on the image carrier 4 with the postage meter machine 1. As can be seen from FIG. 3, the first and the second picture element groups 20 and 21 lie within the overlap region 3.3, whereas the third and fourth picture element groups 22 and 23 are outside the overlap region 3.3.

The first and second picture element groups 20 and 21 are generated by first ink drops. During the first step, the first picture elements 20.1 through 20.3 of the first picture element group 20 are generated with the nozzle group 18. During the third step, the second picture elements 21.1 through 21.3 of the second picture element group 21 are then generated with the nozzle group 19. The first and second picture elements 20.1 and 21.1, 20.2 and 21.2 as well as 20.3 and 21.3 allocated to one another are superimposed on one another and augment one another to in each case form a picture element with a size roughly corresponding to the size of a picture element 22.1 or 23.1 of the third or fourth picture element group 22 or 23, respectively at least in terms of its image appearance.

The drop mass of the ink drops ejected for generating the first picture elements 20.1 through 20.3 in the first step decreases toward the edge 24 of the first partial image 3.1. The same is true of the drop mass of the first ink drops ejected in the third step for generating the second picture elements 21.1 through 21.3, which decreases toward the edge 25 of the second partial image 3.2. As a result, due to the larger picture elements 20.3 and 21.1 generated at the respective edges 26 and 27 of the overlap region 3.3, a shift between the two partial images 3.1 and 3.2 is of hardly any significance, or is of no significance whatsoever, in terms of the image appearance given an imprecise alignment between the two partial images 3.1 and 3.2 arising due to wear or other reasons.

The time control unit controls the ejection time of the first ink drops in the first and third steps such that the appertaining picture elements of the first and second picture element group 20 and 21 only partially overlap.

As can be seen with reference to the example of the picture elements 20.2 and 21.2 as well as the contour 28, the size of the dot on the image carrier 4 generated with superimposed first ink drops in the overlap region 3.3 essentially corresponds to the size of a picture element on the image carrier 4 generated with a second ink drop ejected onto the image carrier 4 outside the overlap region 3.3. This in turn leads to a smooth transition between the first and second partial images 3.1 and 3.2.

The overall mass of the first ink drops employed for generating the picture elements 20.2 and 21.2 slightly exceeds the mass of a second ink drop as employed, for example, for generating the picture element 23.1.

It is clear that in other versions of the invention the drop mass of the first ink drops need not decrease toward the edge of the respective partial image; rather, first ink drops of equal mass are always ejected in the overlap region over the width thereof, these being superimposed similar to the picture elements 20.2 and 21.2.

It is likewise clear that in other versions of the invention two first ink drops associated with one another can be superimposed with dot precision. Dependent on the ink employed and on the material of the image carrier, a noticeably larger total mass of the two first ink drops may be required under this circumstance than compared to an ink drop that is ejected onto the image carrier outside the overlap region.

FIG. 4 shows a schematic view of a portion of picture element groups 20′, 21′, 22′ and 23′ generated on an image carrier 4′ in a further version of the inventive postage meter machine. This postage meter machine essentially corresponds to the embodiment from FIG. 1, so that only the differences shall be discussed below.

As can be seen from FIG. 4, the first and second picture element groups 20′ and 21′ lie within the overlap region 3.3′, whereas the third and fourth picture element groups 22′ and 23′ are outside the overlap region 3.3′.

The first and second picture element groups 20′ and 21′ are generated by first ink drops. During the first step for generating the first partial image 3.1′, the first picture elements 20.1′ and 20.2′ of the first picture element group 20′ are thereby generated with the nozzles 18.2 and 18.4 of a print head (not shown) whose nozzles 18.1 and 18.3 are not driven during this first step. During the third step for generating the second partial image 3.2′, the second picture elements 21.1′ and 21.2′ of the second picture element group 21′ are generated by the nozzles 19.1 and 19.3 of the print head (not shown), whose nozzles 19.2 and 19.4 are not driven during this third step.

Due to the same drop mass, the first and second picture elements 201., 20.2 and 21.1, 21.2 exhibit the same size as a picture element 22.1′ or 23.1′ of the third or fourth picture element group 22′ or 23′. In this version, the drop mass of the first ink drops in the first and second steps is set to zero at individual nozzles—18.1 and 18.3, or 19.2 and 19.4. A smooth transition between the partial images 3.1′ and 3.2′ is achieved as a result of the alternating arrangement of the nozzles driven in this way.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for generating a print image on an image carrier composed of a first partial image and a second partial image disposed transversely offset relative to a first direction, comprising the steps of:
(a) generating a relative motion between an ink drop-ejecting printhead and said image carrier along said first direction for generating said first partial image on said image carrier;
(b) generating a transverse offset between said printhead and said image carrier in a second direction proceeding transversely to said first direction;
(c) generating a relative motion between said printhead and said image carrier along said first direction for generating said second partial image on said image carrier;
(d) selecting said transverse offset in said second step so that an overlap region between said first partial image and said second partial image exists on said image carrier; and
(e) in each of steps (a) and (c), ejecting a plurality of ink drops, including first ink drops, from said printhead onto said image carrier in said overlap region and controlling a drop mass of said first ink drops in steps (a) and (c) to produce a substantially smooth transition between said first partial image and said second partial image on said image carrier.

2. A method as claimed in claim 1 comprising ejecting said first ink drops in steps (a) and (c) so that the first ink drops ejected in step (c) are superimposed on said first ink drops ejected in step (a).

3. A method as claimed in claim 2 comprising selecting said drop mass of said first ink drops in steps (a) and (c) so that a size of a printed dot on said image carrier generated with said superimposed first ink drops in said overlap region substantially equals a size of a printed dot on said image carrier generated with other ink drops ejected onto said image carrier outside of said overlap region.

4. A method as claimed in claim 3 wherein a total mass of said superimposed first ink drops is larger than a drop mass of said other ink drops.

5. A method as claimed in claim 2 wherein the drop mass of said first ink drops in steps (a) and (c) is controlled so that said drop mass of said first ink drops decreases toward an edge of said first partial image in step (a) and toward an edge of said second partial image in step (c).

6. A method as claimed in claim 2 wherein an ejection time of the respective first ink drops ejected in step (a) and in step (c) so that a size of a printed dot on said image carrier generated with said superimposed first ink drops in said overlap region is substantially equal to a size of a printed dot on said image carrier generated by other ink drops ejected onto said image carrier outside of said overlap region.

7. An apparatus for generating a print image on an image carrier composed of a first partial image and a second partial image disposed transversely offset relative to a first direction, comprising:
an ink drop-ejecting printhead;
a printhead positioner connected to said printhead for generating a relative motion between an ink drop-ejecting printhead and said image carrier in a first step along said first direction for generating said first partial image on said image carrier, generating a transverse offset between said printhead and said image carrier in a second step in a second direction proceeding transversely to said first direction, and generating a relative motion between said printhead and said image carrier in a third step along said first direction for generating said second partial image on said image carrier, said transverse offset in said second step producing an overlap region between said first partial image and said second partial image on said image carrier, said printhead in each of said first and third steps, ejecting a plurality of ink drops, including first ink drops, from said printhead onto said image carrier in said overlap region; and
a drop mass controller connected to said printhead for controlling a drop mass of said first ink drops in said first and third steps to produce a substantially smooth transition between said first partial image and said second partial image on said image carrier.

8. An apparatus as claimed in claim 7 wherein said printhead positioner positions said printhead in said first and third steps so that said printhead ejects said first ink drops in said first and third steps so that the first ink drops ejected in said third step are superimposed on said first ink drops ejected in said first step.

9. An apparatus as claimed in claim 8 wherein said drop mass controller controls said drop mass of said first ink drops in said first and third steps so that a size of a printed dot on said image carrier generated with said superimposed first ink drops in said overlap region substantially equals a size of a printed dot on said image carrier generated with other ink drops ejected onto said image carrier outside of said overlap region.

10. An apparatus as claimed in claim 9 wherein said drop mass controller controls said drop mass so that a total mass of said superimposed first ink drops is larger than a drop mass of said other ink drops.

11. An apparatus as claimed in claim 8 wherein said drop mass controller controls the drop mass of said first ink drops in said first and third steps so that said drop mass of said first ink drops decreases toward an edge of said first partial image in said first step and toward an edge of said second partial image in said third step.

12. An apparatus as claimed in claim 8 further comprising a time controller connected to said printhead for controlling an ejection time of the respective first ink drops ejected in said first step and in said third step so that a size of a printed dot on said image carrier generated with said superimposed first ink drops in said overlap region is substantially equal to a size of a printed dot on said image carrier generated by other ink drops ejected onto said image carrier outside of said overlap region.
